(19) United States
(12) Patent Application Publication
(10) Pub. No.: US 2008/0202120 A1
(43) Pub. Date: Aug. 28, 2008

(54) Device Converting Themal Energy into Kinetic One by Using Spontaneous Isothermal Gas Aggregation

(76) Inventor: Nicholas Karyambas, Athens (GR)

Correspondence Address: Nicholas C. Karyambas, 12 Bousgou Street, GR - 114 73 Athens, GR

(21) Appl. No.: 10/585,567

(22) PCT Filed: Apr. 12, 2005
(86) PCT No.: PCT/GR05/00010

§ 371 Date: Jul. 5, 2006

(51) Int. Cl. F03G 7/04; F03G 7/10

(52) U.S. Cl. 60/641.6; 60/641.1

(57) ABSTRACT

Device converting thermal energy into kinetic energy, related to the group of machines based on four-phase basic thermodynamic cycles. It uses rarefied gas in a novel three-phase cycle, of which the first phase is a spontaneous isothermal gas aggregation (0 - - - 1), equivalent to an ideal isothermal compression, followed by an adiabatic expansion (1 - - - 2), with work produced at the expense of the internal thermal energy of the gas via a gas turbine (5), and by an isobaric expansion (2 - - - 0)), where the expanded gas is reheated via a heat exchanger (6), while cooling the ambient air (7).

The spontaneous aggregation (0 - - - 1) is accomplished when the gas passes through numerous special microscopic holes, like slot (26) and cone (27) with diverging inner surfaces, cavity (28) with concave spherical surfaces, where the molecular layer adsorbed upon the inner walls of the holes, slightly diverts the (normally) uniform rebound of the molecules to directions inclining towards the perpendiculars to the reflecting surfaces, with the result that a small amount of gas is passing through the holes spontaneously achieving the aggregated output.

My invention is a device converting thermal energy into kinetic one, related to the group of machines using four-phase basic thermodynamic processes like Carnot or Otto cycles. These devices need, for their operation, some kind of available outside heat source to be converted into kinetic energy. They consist of continuously lubricated moving parts, working in high temperatures, with quality deteriorating by usage and with noise emission.

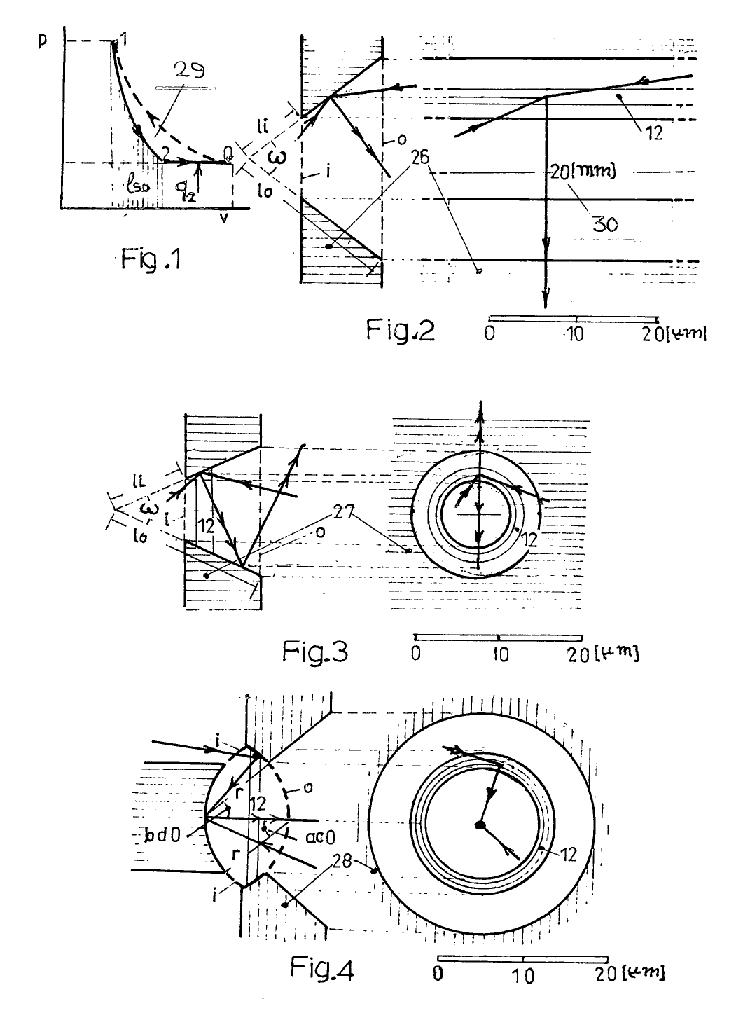

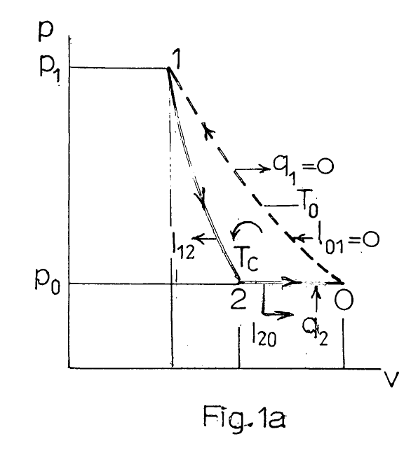

My invention uses rarefied gas in a novel three-phase thermodynamic cycle, as shown in FIG. 1 (p,v diagram), of which the first phase is a spontaneous isothermal gas aggregation (0 - - - 1), equivalent to an ideal isothermal compression, the second phase is an adiabatic expansion (1 - - - 2), with work produced via an expander and the third one is an isobaric expansion (2 - - - 0) where, by means of an exchanger, the cooled gas is reheated again (q₂) by cooling the ambient air. The shaded area below the adiabatic path (1 - - - 2) represents the work done at the expense of the internal thermal energy of the gas(lso). The first phase arises when the gas passes through numerous special microscopic holes, with sizes comparable to the mean free path of the molecules, so that the latter do not collide with each other but only with the walls. The solid lines with the arrows show the central paths of the swarms of molecules. I have thought up smart geometric shapes for these holes, like slot (FIG. 2) and cone (FIG. 3) with diverging inner surfaces, cavity (FIG. 4) with segments of spherical inner surfaces, in order that the molecules may take advantage of a phenomenon (to be discussed further down the text), with the result that, during successive rebounds upon the inner walls, they tend to move forward, forming a small but discrete net flow from the input(i) to the output (o). Under these special conditions the gas comes out of the holes spontaneously and isothermally, entering a room with increased density. Obviously, there result five advantages by the use of my invention, ie (1) energy production at the expense of the internal thermal energy of the gas, which then is reheated by the ambient air, (2) refrigeration for any domestic appliances, (3) no moving parts (except the expander), (4) high quality operation and (5) no noise.

### DESCRIPTION

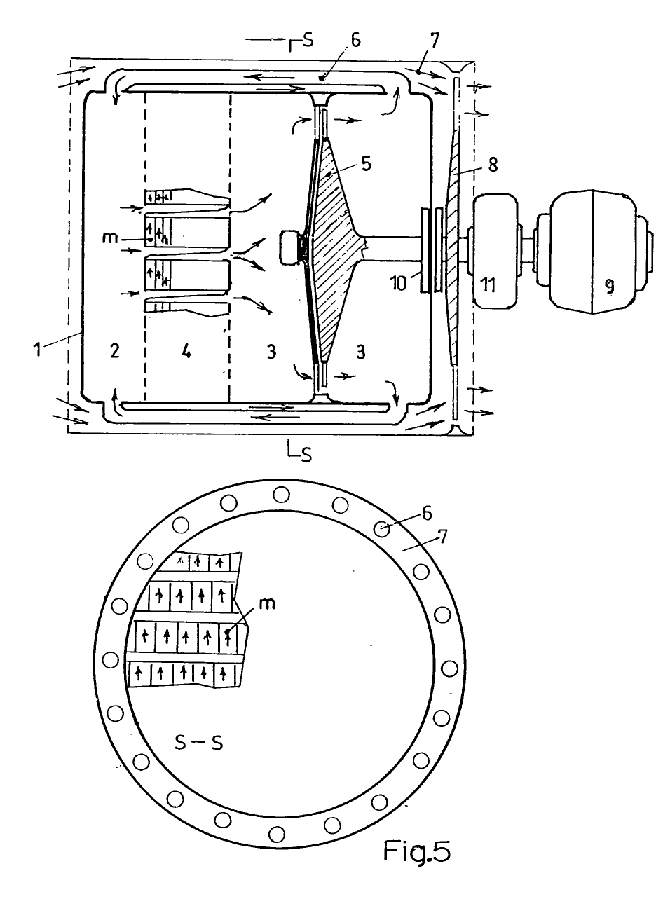

FIG. 5 (parallel view and cross section S-S) shows the device, consisting of a vacuum glassvessel (1) divided into two rooms (2) and (3) by a region (4) containing the microscopic holes' assembly and consisting of a great number of holes grouped into standard small modules (m), all arranged in a parallel layout as regards the gas flow. The closed circuit of the gas flow is supplemented with an adiabatic expander (5), within room (3), and a heat exchanger (6) in the return path of the gas from (3) to (2), transferring heat from the ambient air (7) to the gas with the help of ventilator (8). With suitable pressure difference between (2) and (3) an optimum flow is established, so that the device is continuously performing work, eg by means of a generator (9), coupled to the expander through a magnetic clutch (10) and a speed reduction gear (11) (if needed), and at the same time it offers cooling possibilities.

### The Phenomenon.

The operation of the device is based on a phenomenon observed at the time of the experimental research and evaluation of the external friction of gases [1], where it was shown that the molecules in a rarefied gas, rebounded from the inner walls of the container, under suitable vacuum pressure, do not exactly obey the so called cosine-law (uniform rebound to all directions) [2, p. 27], but, due to the existence of a molecular layer, adsorbed upon the walls, their path directions tend to slightly incline towards the perpendiculars to the walls, provided that the inner surfaces are quite smooth and the size of the container comparable with the mean free path of the molecules. Both of these properties are very important. The surface smoothness inside the holes must be perfect enough for the adsorption layer to cover the surface irregularities completely, otherwise the layer action is cancelled and the cosine-law prevails again. Fortunately, nowadays a state-of-the-art value of surface roughness has been realized down to 1 nm, rms and even better [3], while in earlier decades values of less than 20 nm apparently had not been reached [4, p. 622]. With regard to the size, I have taken the fundamental dimension of the holes l=10 μm, which size is relatively easily realizable, happily in accordance with the technological progress of these days on Micro-Electro-Mechanical-Systems (MEMS) [5, p. 56] and which is conveniently adaptable to the selected mean free path λ=10 μm, as well as to the corresponding pressure [6, p. 24], within the range of a well developed molecular layer. Finally, I consider worth mentioning that this peculiar behaviour of the molecular layers offers a natural explanation of the repulsive forces between adjacent corpuscles in the Brownien motion phenomenon and also in the expansion of dust in the air [1, p. 331].

### INDUSTRIAL APPLICABILITY

The device has not been realized and tested experimentally. Nevertheless, its successful working ability is indeed proved indirectly, because it is based on the experimental and theoretical work mentioned in [1] as well as on a simulation method, assisted by electronic computer programs, to be described quantitavely as follows.

### The Simulation Method.

In order to evaluate the amount of flow through the microscopic holes, it is necessary first to calculate the number of molecules emitted from any point A of the inner walls and fallen on any other point B as a function of the geometric parameters (dimensions, angles) of the holes.

Following the computer symbolism, let

AB[m]=distance between two points A and B located anywhere on the inner walls of a hole.
na[sw/m³]=swarm of molecules per unit volume (volume density) around A
dna[sw/(m²*s)]=swarm of molecules per unit area per unit time rebounded from A within an infinitesimal stereo-angle dΩ[sr] towards B.
v[m/s]=arithmetic mean velocity of the molecules
cfa, cfb=cosines of angles φ_{A},φ_{B} between AB and the perpendiculars on the respective infinitesimal facets dsa and dsb at A and B.
na*v/4[sw/(m²*s)]=molecules per unit area per unit time (surface density) re-bounded from A to the inner hemisphere.

Then, in the absence of the adsorbed layer the cosine-law is expressed as follows [2, p. 27], (Pi means π):

dna=na*v/(4*Pi)*cfa*dΩ=na*v/4*cfa*cfb/(Pi*AB²)*dsb
Or, in reduced form (divided by no*v/4 and multiplied by dsa/dsb)

dna*dsa/(no*v/4*dsb)=wa*cfa*cfb/(Pi*AB²)*dsa (1)

where wa=(na*v/4)/(no*v/4)=relative surface density on A, wo=no*v/4=input surface density. On integration of dΩ over the inner hemisphere we obtain the basic quantity na*v/4. The factor cfa expresses the cosine-law.

Now, in the presence of the adsorbed layer the cosine-law is to be modified, ie the factor cfa should be substituted by [1, p. 325] {[1−⅔*f(p)]*cfa+f(p)*cfa²}, where f(p) is an increasing function with the pressure and with f(p)ₘₐₓ= 3/2, occurring at p=I, 918 mmHg, which corresponds to ( 3/2*cfa²) as a substitute of cfa. In that case

dna*dsa/(no*v/4*dsb)=wa* 3/2*cfa²*cfb/(Pi*AB²)*dsa (2)

This formula may be used at least also for pressures above 1.918[mmHg], up to 23,2 mmHg, which corresponds to the maximum thickness of the layer and beyond, given that it does not drop quickly after the maximum [1, p. 305, Table]. The forms of the holes are selected to possess some kind of symmetry so that the inner walls, as reflecting surfaces, may be divided into a large number (n) of strips (for the slots) and rings (for the cones and cavities), as shown in (12) of FIGS. 2,3,4. The same thing may be done on the input (i) and output (o) surfaces. Then, the relative density wa is constant along a strip or a ring I have to remark that wa, when referred to the walls is an unknown, while when referred to the input surface it is known and equal to 1, and when referred to the output surface it is equal to the compression factor k between input and output. So, for each point B we are allowed to integrate (sum up) equations (1) and (2) over each strip or ring, having previously expressed these equations as functions of the geometric parameters of the holes. After integration (addition) and by putting i for A_{i(=1,2,3, . . . n)} and j for B_{j(=1,2,3, . . . )}, I rewrite equations (1) and (2) in a new form

swᵢⱼ=wᵢ*fbbpᵢⱼ(layer absent)|

swᵢⱼᵢⱼ=wᵢ*fbbpᵢⱼ(layer present)| (3)

where swᵢⱼ=swarm of molecules per strip or ring per unit time, rebounded from the strip or ring containing Aᵢ to Bⱼ, per unit area for B.

fbbpᵢⱼ=transmission coefficients from a strip or ring i to point j, that are calculated as functions of the geometric parameters. In order to find the n unknown densities, I express, in the form of equation, the following equality which, under steady-state conditions, takes place between the number of molecules fallen on any reflecting point j and the number wⱼ rebounded from the same point.

Σ_{i(=1,2,3, . . . n)}swᵢⱼ[reflecting surface]+Σ_{i(=1,2,3, . . . n)}swᵢⱼ[input surface]+k*Σ_{i(=1,2,3, . . . n)}swᵢⱼ[output surface]=wⱼ (4)

The first sum includes the unknown variables wᵢ. The second and third sums are known. In terms of equations (3) this equality, appropriately rearranged, becomes an n-variable linear equation for point j:

Σ_{1(=1,2,3, . . . j-1)}fbbpᵢⱼ*wᵢ+(fbbpᵢⱼ−1)*wⱼ+Σ_{i(=j+1,j+2, . . . n)}fbbpᵢⱼ*wᵢ=−Σ_{i(=1,2,3, . . . n)}fbbpᵢⱼ(input)−k*Σ_{i(=1,2,3, . . . n)}fbbpᵢⱼ(output) (5)

Finally, we have a system of n n-variable linear equations, which may be solved with the help of Gauss algorithm [7, p. 44-28].

### Three Examples.

Having established the numerical values of the n variables (densities), both for layer absence and layer presence conditions, it is easy to calculate the algebraic sum Fl(k) of flows of molecules through the input or output (it is the same), including all the path combinations. This net overall flow Fl(k) is a linear function of k, reduced to the unit of input surface density no*v/4 and to the unit of area lₒ² (slots and cones) [FIGS. 2,3] and r² (cavities) [FIG. 4], (lₒ=2*l, r=l). Under layer absence and for k=1 we have Fl(l)=0, which complies with the cosine-law. Under layer presence sad for k=1 we have Fl(l)=Flm(maximum) and for k=km(maximum) the flow stops, ie Fl(km)=0. Under layer presence

Fl(k)=Flm*(km−k)/(km−1) (6)

Flm and km are also functions of the geometric parameters of the holes, ie li,ω for slots and cones (FIGS. 2,3) and ac0, bd0 for cavities (FIG. 4). Optimum values:

| Geometric parameters | slot | cone | cavity |
|---|---|---|---|
| li(=li/lo) | 0.4 | 0.5 | |
| ω[rad] | 1.4 | 0.8 | |
| ac0 = bd0[rad] | | | 0.7227 |
| Overall flow Flm | 0.052 | 0.0218 | 0.1600 |
| Compression factor km | 1.1100 | 1.2500 | 1.2000 |

km is found by the trial-and-error method or directly with the formula:

km=(A−Flm)/A (A=program under layer presence, k=1, zero input) (7).

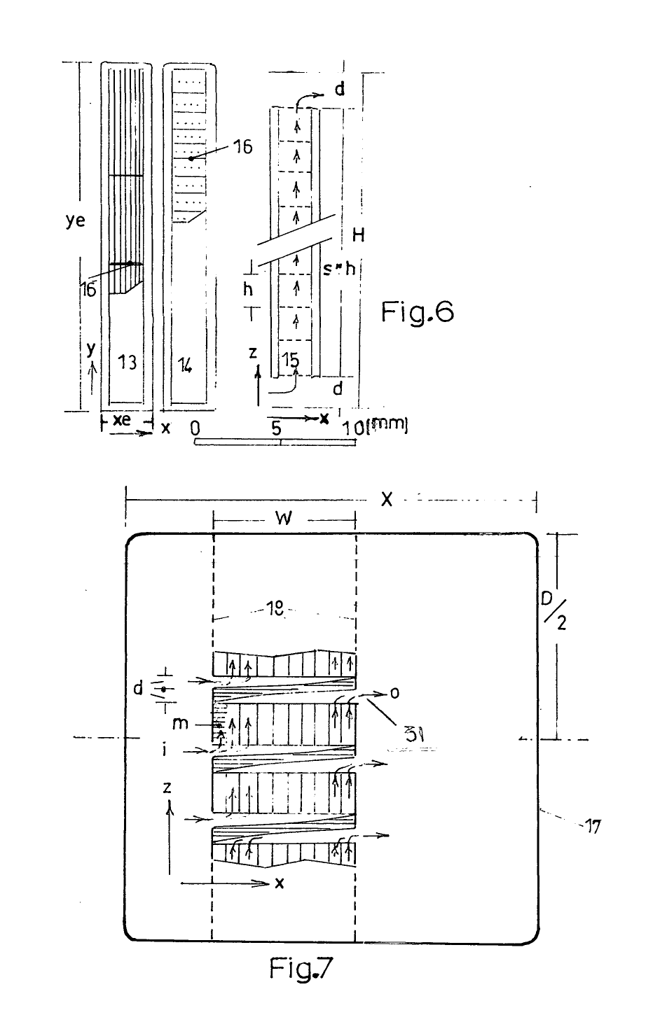

Because of the great number of holes needed to achieve a somewhat remarkable result, I have organized the construction of the device in a form of small modules, as shown in FIG. 6, consisting of a certain number (s) of parallel very thin panels, say xe(=0.3 cm)*ye(=2.1 cm), each perforated with a number of holes ((13) for parallel slots of length all the way of the module's y-dimension, (14) for cones and cavities) and arranged in a pile (15) of height

H(s)=s*h+2*d (8)

where h(=0.2 cm)=distance between successive panels, d(=1 cm)=input or output air ducts. The arrows show the path of the molecules. Suitable supporting rods ((4), solid lines) fix the panels in place. Along z we have (s) holes in series and the molecule compression factor is k^{s} (=k₁*k₂* . . . *kₛ),(k₁=k₂= . . . =kₛ=k). The number Nmod(=ax*ay) of holes per panel or of piles of holes per module is estimated to

| | Slot | Cone | Cavity | |
|---|---|---|---|---|
| Nmod = ax * ay = | 80 * (2 cm/lo) | 100 * 400 | 66 * 400 | (9) |

Two gases, Helium and Hydrogen, have been chosen as the most suitable for use with the device. The present examples will work with Hydrogen (mass g[kg]=0.3347/10²⁶, arithmetic mean velocity v[m/s]=1693 [6, p. 323]).

Now, FIG. 7 (not in scale) shows a possible arrangement (18) of these modules (m) within apart O=0.04241 m³ (W=0.054 m) of a space (17) with dimensions X=1 m and D(diameter)−1 m, which will contain the device of FIG. 5 (modules' assembly and expander). I have taken a limited value of O in order to accommodate a heat exchanger of reasonable size for the device. The arrows indicate the gas flow directions (i=input, o=output). Then, the number v(s) of modules contained in O and the whole number Np(s) of piles of holes is,

v(s)=O/(xe*ye*H(s)) and Np(s)=Nmod*v(s) (10)

With regard to FIG. 1: Work done per cycle(shaded area) [8, p. 244]

ls[J/kg]=R[J/(kg*K)]*To[K]/(n−1)*{1−(1/k^{s})^{((n-1)/n)}} (11)

### R[4, p. 872]=4124, n[4, p. 872]=1.409

To[K]=253 for slots, 273 for cones and cavities (see next paragraph).

In order to maximize the output power, the following expression a(k), which is a product of three factors in Eqs (6), (8), (11), contained in the power output formula, must be maximized with respect to (k) and with (s) as a parameter, given that (s) may not exceed a limit (so), where the mean free path still remains “free” within the last holes,

a(k)=(km−k)/(km−1)/(s*h+2*d)*{1−(1/k^{s})^{((n-1)/n)}} (12),

to find k=ko, s=so. Computed values of ko, so, Fl(ko), H(so), v(so), Np(so), lso follow:

| | slot | cone | cavity |
|---|---|---|---|
| ko | 1.05225 | 1.106 | 1.085 |
| so | 17 | 9 | 11 |
| Fl(ko) | 0.0273 | 0.01256 | 0.0920 |
| H(so)[cm] | 5.4 | 3.8 | 4.2 |
| v(so) | 12465 | 17715 | 16028 |
| Np(so)/10⁶ | 997.2 | 708.6 | 423.1 |
| lso[J/kg] | 566933 | 637950 | 630466 |

With plenty of margin (h) between successive panels and ample input-output air ducts (d), the speed of flow outside the holes is kept within a few meters per second, practically eliminating friction losses and noise.

### Expander and Heat Exchanger

The expander [9, p. 449] is a single-stage reaction gas turbine, accommodated within the device (FIG. 5. (5)). Its main features of interest here are the wheel diameter (D), the revolving speed (n) and the efficiency factor βexp=0.825 [9, p. 271].

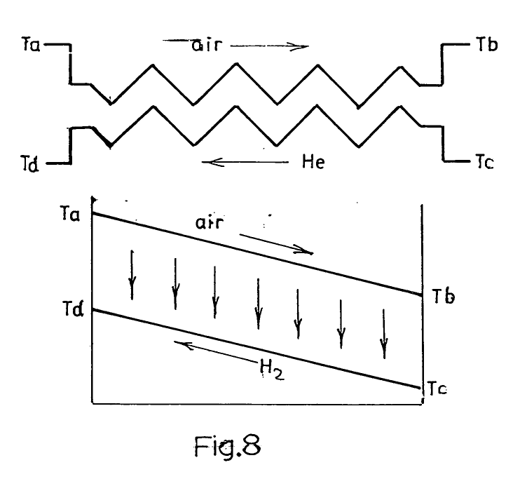

The exchanger [4, p. 470-472] is constituted of 30 glasstubes (FIG. 5, (6)) in parallel, 0.05 m in diameter, 1 m of length, situated along and around the device. The gas H₂ passes(in laminar flow) through the tubes, while air (FIG. 5, (7)) is forced (in turbulent flow) around them, in the opposite direction, as shown by the arrows, by means of the ventilator (FIG. 5, (8)), with velocities 2 to 5 m/s. In order to realize such a reasonable size of this component, it was necessary to let a greater temperature drop between warm air and cool H₂(40° C. for slots, 20° C. for cones and cavities). FIG. 8 shows schematically [9, p. 271] the heat exchanger and the corresponding flow diagram. The horizontal and slanted arrows show air- and H₂-flow, vertical arrows show heat-flow. The (computed) pressure drop, in the H₂-flow is too small to be taken into consideration. Calculated values of (D), (n), and the working pressures and temperatures are as follows (cᵥ[kcal/(kg*K)]=2.41 [4, p. 871], e[kcal/J]=0.2388/10³):

| | Slot | Cone | Cavity |
|---|---|---|---|
| EXPANDER D[m]-n[rev/min] | 0.60-3630 | 0.41-3630 | 0.44-3630 |

| Pressure | input p₁ = po * ko\hat{ }so | 1020 * 2.377 | 1121 * 2.48 | 1121 * 2.45 |
|---|---|---|---|---|
| | output po[Pa] | 1020 | 1121 | 1121 |
| Temperatue input To(=Td) | | 253 | 273 | 273 |
| Output Tc = To − βexp * lso * e/cᵥ | | 206.7 | 220.8 | 221.5 |
| EXCHANGER Input air tempTa | | 293 | 293 | 293 |
| Output air temp. | Tb | 246.7(−26.3° C.) | 240.8(−32.2° C.) | 241.5(−31.5° C.) |
| Input H₂ temp. | Tc | 206.7 | 220.8 | 221.5 |
| Output H₂ temp. | Td(=To) | 253 | 273 | 273 |

| | | | |
|---|---|---|---|
| Ta − Tb = Td − Tc | 46.3 | 52.2 | 51.5 |
| Air flow rate[m³/s] | 0.95 | 0.66 | 0.77 |
| Ventilator Power Ivent.[w] | 190 | 120 | 140 |

Hydorgen re-heating thermal energy (FIG. 1)[8,p.235]:q₂=cₚ8(To−Tc)

| | Slot | Cone | Cavity |
|---|---|---|---|
| q₂[kcal/kg] | 157.42 | 177.48 | 175.10 |

### NumerIcal Results.

Finally, I proceed to calculate all the factors which determine the output power: Loschimdt number[6,p.17](p=1,02*10⁵Pa,T=273k)=. =2,687*10²⁵molecules/m³

| | | Slot | Cone | Cavity |
|---|---|---|---|---|
| Input pressure | po[Pa] | 1020 | 1121 | 1121 |
| | po[mmHg] | 7.68 | 8.41 | 8.41 |
| Input Temperatue | To[K] | 253 | 273 | 273 |
| Input Vol.Density | no[sw/m³]/10²³ | 2.900 | 2.950 | 2.950 |
| Hydrogen Velocity | v[m/s] | 1630 | 1693 | 1693 |
| Input Surf.Density: | | | | |
| wo = (no * v/4)[sw/ | | 1182 | 1249 | 1249 |
| (m² * s]/10²³ | | | | |
| lo[m] = 20/10⁶ | r[m] = 10/10⁶ | | | |

Mass flow-rate per hole:
Slots and Cones gf[kg/s]=g*Fl(ko)*wo*lo²
Cavities gf[kg/s]=g*Fl(ko)*wo*r²
Total flow rate G[kg/s]=gf*Np(so)
Power output of expander Iexp[watt]=βexp*lso*G:
Power output (pract.) Ipr[watt]=Iexp−Ivent

| | Slots | Cones | Cavities |
|---|---|---|---|
| Fl(ko) | 0.0273 | 0.01256 | 0.0920 |
| gf[kg/s] * 10¹² | 4.32 | 2.10 | 3.85 |
| G[kg/s] * 10³ | 4.308 | 1.487 | 1.629 |
| lso[J/kg] | 566933 | 637950 | 630466 |
| Iexp[watt] | 2015 | 783 | 849 |
| Ivent[watt] | 190 | 120 | 140 |
| Ipract[watt] | 1825 | 663 | 709 |

### Construction Hints.

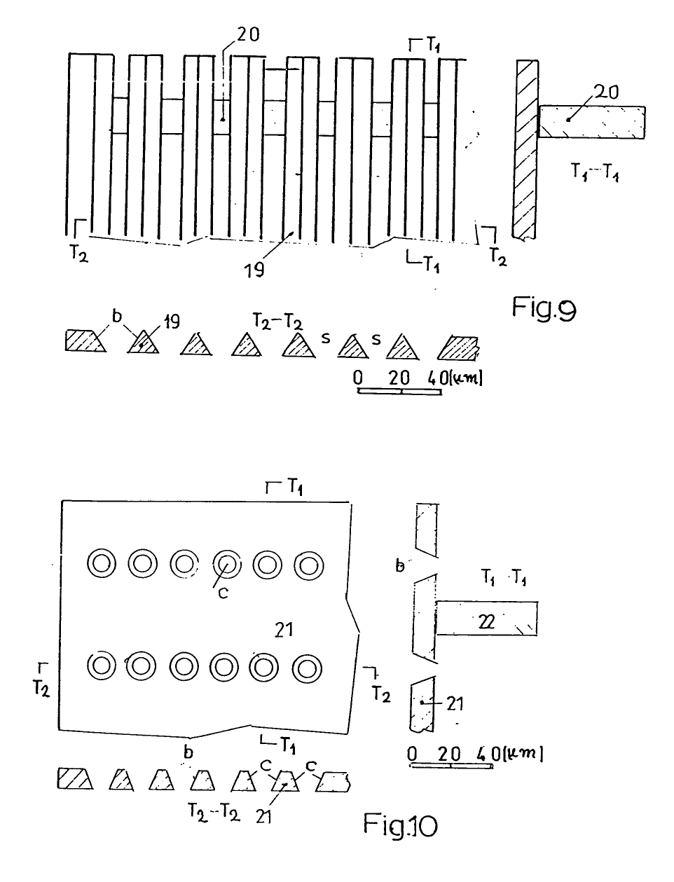

Mass production can be achieved by the method of pressing [10, p. 8-1], not excluding any other competent method. As construction material I would propose glass, ceramic, silicon or the like, used in semiconductor technology. FIG. 9 shows a slot panel ie an arrangement of parallel triangular rods (19), forming slots (s) in between, lying on supporting rods (20) (cross-section T₁-T₁) at suitable intervals. Cross-section T₂-T₂ of rods (1). The distance between successive panels is h=0.2 cm. Both forms of rods can easily be manufactured in mass production with the active surface (b) made very smooth by advanced polishing processes [5, p. 56].

The slot solution presents evident advantages over the other two solutions in (a) manufacture (b) greater output power per unit volume.

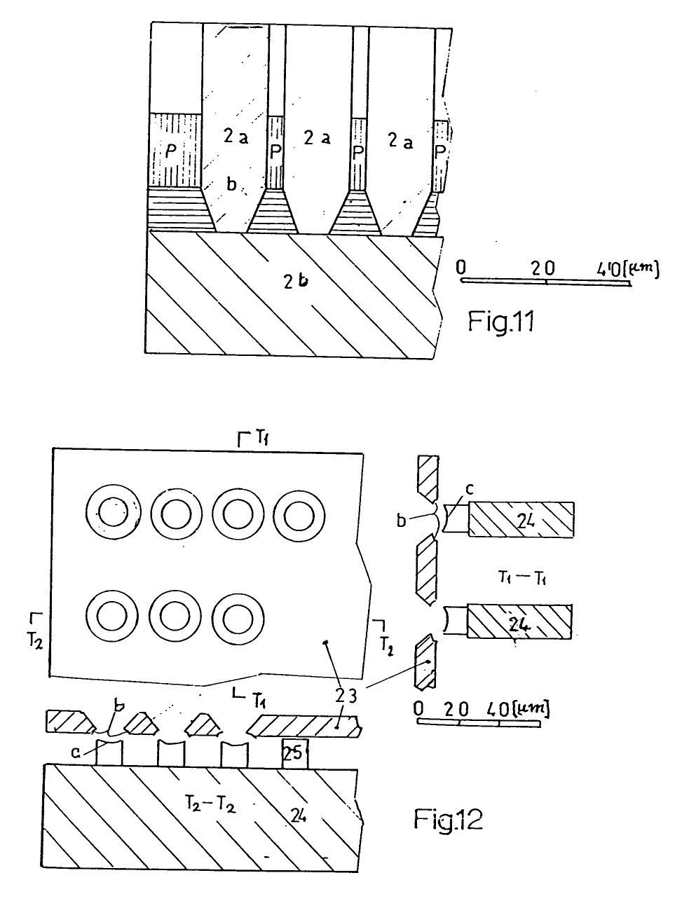

FIG. 10 shows a cone panel (21) with cones (c) (cross-section T₂-T₂), arranged in series along x, lying on supporting rods (22) (cross-section T₁-T₁), which are placed between adjacent cone series. Intervals between successive panels are equal to h=0.2 cm. The cone active surface (b) is made very smooth. FIG. 11 shows a possible scheme for cone panel fabrication, with the help of molds (2a, cylinders), (2b) and (p) as pressing means.

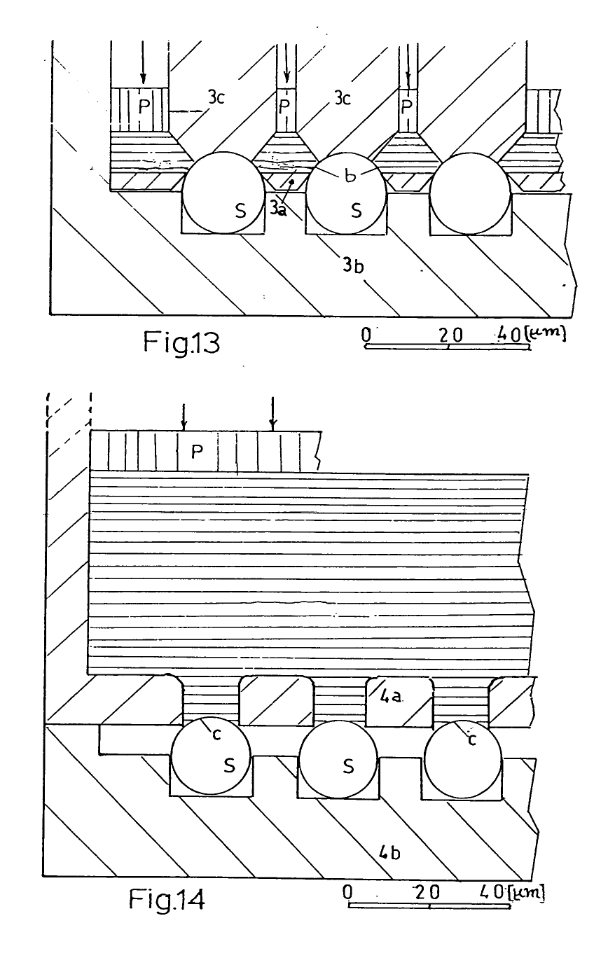

Finally, FIG. 12 shows a cavity panel (23), carrying the holes with the active spherical surfaces (b) and the supporting rods (24) (cross-sections (T₁-T₁,T₂-T₂)), carrying the active spherical surfaces (c). At suitable intervals along the rods (24), a contact rod (25) is made in place of the corresponding active surface (c), with elimination of the opposite side hole, in order that the panel is rigidly supported. FIGS. 13 and 14 show the forming of the active surfaces (b) and (c) of the cavity respectively, with the help of molds (3a),(3b),(3c, cylinders), (p) for FIG. 13 and (4a),(4b),(p) for FIG. 14. To achieve the exact spherical surface the molds should be equipped with tiny balls s (dia. 20 μm), with smooth spherical shape, like those used in miniature ball-bearings [11].

### Computer Programs.

A 3½ in floppy disc is available, containing the programs (written in Q-basic) of the present invention.

### REFERENCES

[1] Annalen der Physik, W. Gaede, 41, S.289-336, 1913
[2] Physik und Technik des Hochvacuums, A. Goetz, F. Vieweg, Braunschweig 1926.
[3] Optical Surfices Ltd, Godstone Road Kenley Surrey, England CR8 5AA (correspondance).
[4] Dubbel, Taschenbuch fur den Machinenbau I, Springer-Verlag, 13. Auflage, 1974.
[5] IEEE Spectrum, January 1999.
[6] Fundamentals of Vacuum Techniques, A. Pipko et al., MIR Publishers, Moscow, 1984
[7] Reference Data for Radio Engineers, H. W. Sams and Co, Inc. (ITT), 1969.
[8] Engineering Thermodynamics, V. A. Kirillin et al., MIR Publishers, Moscow, 1976.
[9] Principles of Jet Propulsion and Gas Turbines, M. J. Zucrow, John Wiley & Sons, Inc., New York, 1948.
[10] Glass Engineering Handbook, G. W. McLelland, E. B. Shand McGraw Hill, Inc., 1984.
[11] Myonic GmbH, Miniature Bearings Division, Biel-Bienne, Swingerland.

1. Device converting thermal energy into kinetic energy, related to the group of thermodynamic machines using adiabatic compressors, adiabatic expanders and heat exchangers and converting thermal energy into kinetic one by means of an available outside heat source characterized by the fact that:
(a) this device uses a rarefied gas in a novel three-phase cycle (29) of which the first phase (1 - - - 2) is an adiabatic expansion, the second phase (2 - - - 0) is an isobaric expansion and the third one, dotted line (0 - - - 1), is a spontaneous isothermal gas aggregation, equivalent to ideal isothermal compression.
(b) Said device consists of a vacuum glassvessel (1), equipped with an adiabatic expander (5), performing phase (1 - - - 2) and a heat exchanger (6,7), performing phase (2 - - - 0), and divided into rooms (2) and (3) by a region (4) containing numerous slots (26), performing phase (0 - - - 1) and having:
(i) diverging inner surfaces (26),
(ii) microscopic cross section comparable with the mean free path of the molecules and
(iii) a length of 20 nm (30),
said slots being grouped together as spacings (s) between adjacent parallel triangular rods (19), into standard small modules (m) (13), and arranged in a parallel layout with regard to the gas flow, as shown by the arrows (31).
(c) Said device works by drawing heat only from the ambient air, without any other outside heat source.
